(19) United States
(12) Patent Application Publication
(10) Pub. No.: US 2012/0012446 A1
(43) Pub. Date: Jan. 19, 2012

(54) ILLUMINATED KEYBOARD PROVIDED DISTINGUISHABLE KEY LOCATIONS

(76) Inventor: Chin-Hsiu HWA, Taipei Hsien (TW)

(21) Appl. No.: 12/836,919

(22) Filed: Jul. 15, 2010

(51) Int. Cl. H01H 9/00

(52) U.S. Cl. 200/314

(57) ABSTRACT

An illuminated keyboard provided distinguishable key locations includes a keyboard portion and a luminous portion. The keyboard portion includes a baseboard and a plurality of rows of keycaps located on the baseboard. The keycaps and the baseboard are bridged by a plurality of moving mechanisms. The keycaps are movable up and down against the baseboard through the moving mechanisms. The keycaps on neighboring rows are spaced by a first gap. The neighboring keycaps on each row are spaced by a second gap. The luminous portion is located between the keycaps and the baseboard and has a plurality of first lighting sections corresponding to the first gap and a plurality of second lighting sections corresponding to the second gap. The second lighting section has two ends connecting to two adjacent first lighting sections. Thus luminosities of the keycaps and the first and second gaps are different to facilitate distinguishing of the locations of the keys.

### FIELD OF THE INVENTION

The present invention relates to an illuminated keyboard and particularly to an illuminated keyboard that provides distinguishable key locations through varying luminosities.

### BACKGROUND OF THE INVENTION

In the technology information age today computers have been indispensable in people's life. Almost every line of business has to rely on computers to aid operation, either desktop computers or notebook computers. The application scope and time are extensive. They could be used in any environments. However, in a low luminosity or dark environment, not sufficient light often causes inaccurate keyboard strokes and results in erroneous signal output. To solve such a problem many types of illuminated keyboards have been developed, such as U.S. Pat. Nos. 6,179,432, 6,199,996, 6,284,988, 6,322,229 and 6,554,442. They all disclose an illuminated keyboard which mainly has a lighting sheet held in the keyboard to illuminate keycaps to facilitate user operation of the keyboard in a light-deficient or dark environment.

However, the aforesaid techniques mostly have an elastic element and a moving mechanism interposed between the lighting element and key caps. The keycaps, elastic element and moving mechanism are mostly made of a light-permeable material (some of the techniques have the keycaps made of an opaque material with the character portion made of the light-permeable material). When the entire lighting sheet emits light the keyboard is evenly illuminated in a backlit manner. Such an illuminated keyboard generally is used in a light-deficient or dark environment, such as in an airplane, vehicle or the like. But with the entire keyboard emitting light evenly the total luminosity is too strong that could affect people nearby. Moreover, in the lower luminosity environment user's visual capability on the keyboard is lower naturally, with the entire keyboard luminous evenly user is difficult to differentiate the character notation of each keycap. Even though the characters and symbols are made from opaque material, or the keycap is made from impermeable material while the character notation made from permeable material, light emitting from the gaps between the adjacent keycaps still make the use hard to recognize the characters. For a user who does not well memorize the positions of the characters the situation is particularly serious, and he may thus input wrong instructions.

### SUMMARY OF THE INVENTION

An objection of the present invention is to solve the aforesaid problem by forming different luminosities between keys and gaps to distinguish the relevant locations of the keys.

To achieve the foregoing objection the present invention provides an illuminated keyboard that provides distinguishable key locations. It includes a keyboard portion and a luminous portion. The keyboard portion has a baseboard and a plurality of rows of keycaps located on the baseboard. The keycaps and the baseboard are bridged by a plurality of moving mechanisms. The keycaps are movable up and down against the baseboard through the moving mechanisms. The keycaps on neighboring rows are spaced by a first gap. The neighboring keycaps on each row are spaced by a second gap. The luminous portion is located between the keycaps and the baseboard and has a plurality of first lighting sections corresponding to the first gap and a plurality of second lighting sections corresponding to the second gap. The second lighting section has two ends connecting to two adjacent first lighting sections.

Through the first and second lighting sections the luminosities of the keycaps and the first and second gaps around the keycaps of the keyboard are different to facilitate distinguishing of the locations of the keycaps to improve keystroke accuracy.

The foregoing, as well as additional objects, features and advantages of the present invention will be more readily apparent from the following detailed description, which proceeds with reference to the accompanying drawings.

### BRIEF DESCRIPTION OF THE DRAWINGS

FIG. 1 is a top view of the keycaps of the present invention.

FIG. 2 is a top view of the luminous portion of the present invention.

FIG. 3 is an exploded decomposition view of the present invention.

FIG. 4 is a cross section of a first embodiment of the present invention.

FIG. 5 is another cross section of the first embodiment of the present invention.

FIG. 6 is a cross section of a second embodiment of the present invention.

FIG. 7 is another cross section of the second embodiment of present the invention.

### DETAILED DESCRIPTION OF THE PREFERRED EMBODIMENTS

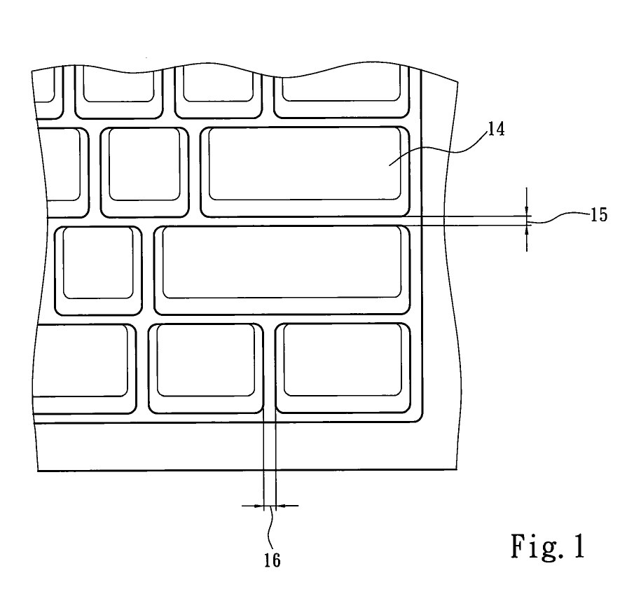

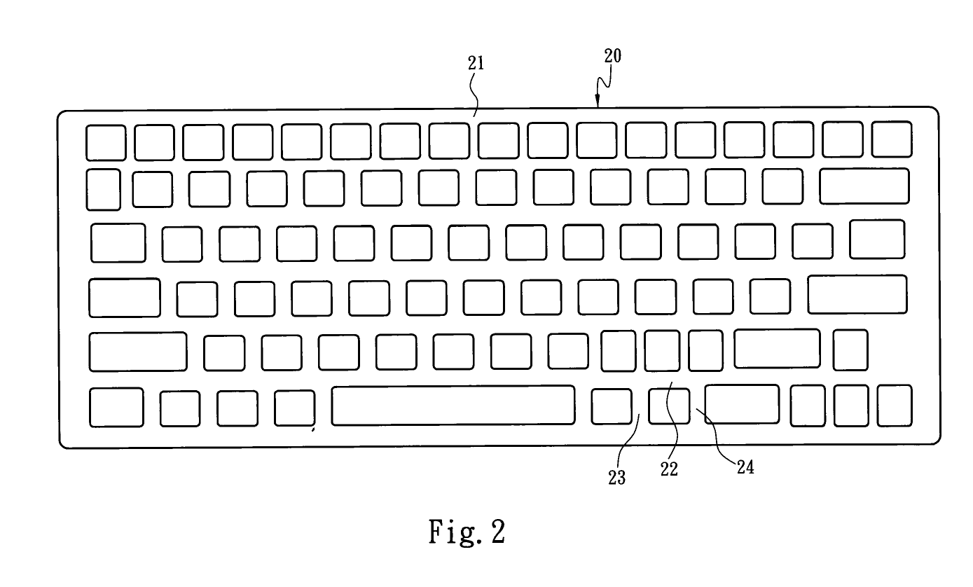

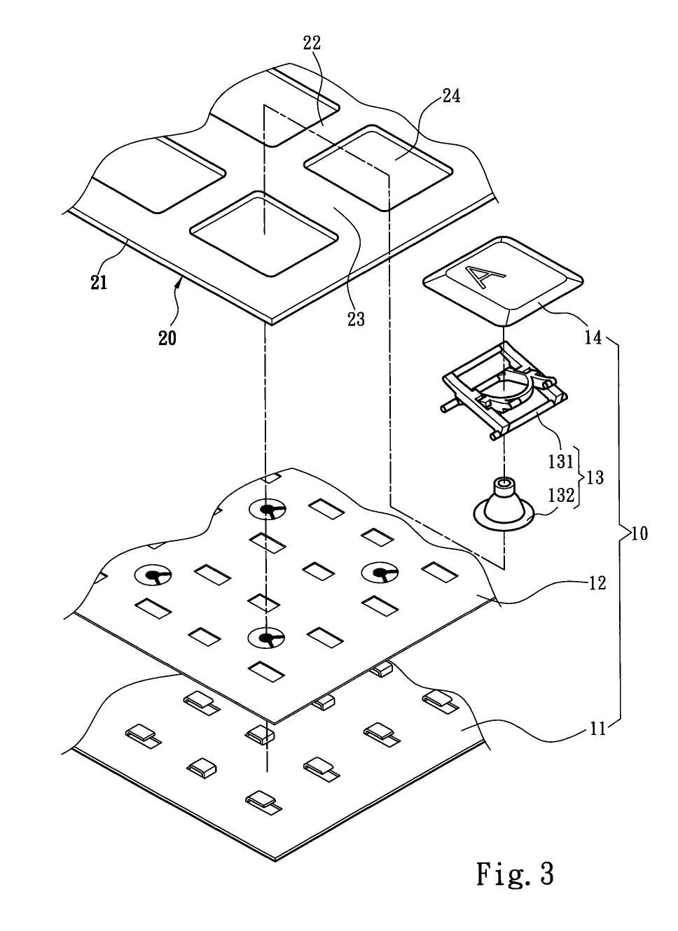

Please referring to FIGS. 1, 2 and 3, the present invention provides an illuminated keyboard that provides distinguishable key locations. It mainly includes a keyboard portion 10 and a luminous portion 20 located on the keyboard portion 10. The keyboard portion 10 includes a baseboard 11 and a plurality of rows of keycaps 14 located on the baseboard 11. The keycaps 14 of neighboring rows are spaced by a first gap 15, and the neighboring keycaps 14 on each row are spaced by a second gap 16. The keycaps 14 and the baseboard 11 are bridged by a plurality of moving mechanisms 13. Each moving mechanism 13 includes a movable member 131 bridging the keycap 14 and the baseboard 11 and an elastic element 132 supporting the keycap 14 to provide a return force for the keycap 14. The keycap 14 can be stricken and moved up and down against the baseboard 11 through the moving mechanism 13. Moreover, the keyboard portion 10 further contains a circuit board 12 interposed between the keycaps 14 and the baseboard 11 to generate command signals by compression and touching of the elastic element 132 while the keycaps 14 are moved up and down.

The luminous portion 20 is located between the keycaps 14 and the baseboard 11 above the circuit board 12. Hence the circuit board 12 is interposed between the baseboard 11 and luminous portion 20. The luminous portion 20 is a light conductive object 21 such as a light conductive panel, and has a plurality of first lighting sections 22 corresponding to the first gap 15 and a plurality of second lighting sections 23 corresponding to the second gap 16. The second lighting section 23 has two ends connecting to two adjacent first lighting sections 22. The first and second lighting sections 22 and 23 are formed integrally, and also form an opening 24 corresponding to the keycap 14 to hold the elastic element 132. Thus forms the main structure of the present invention.

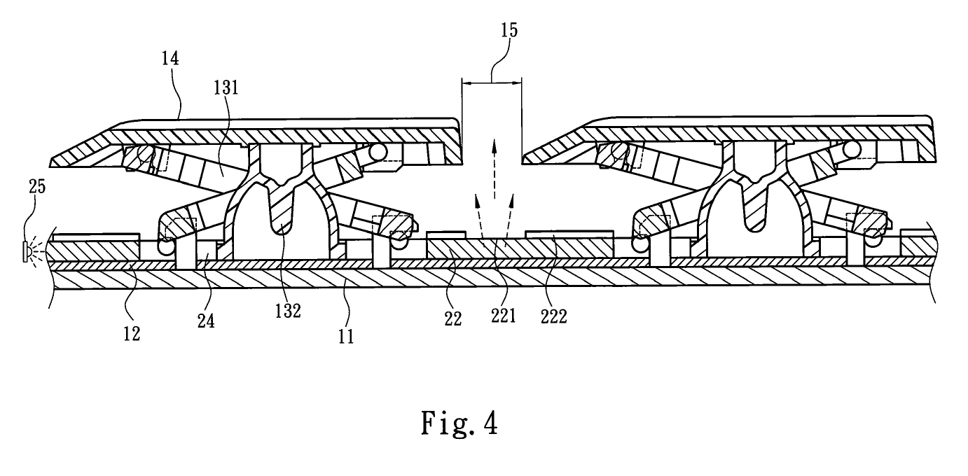

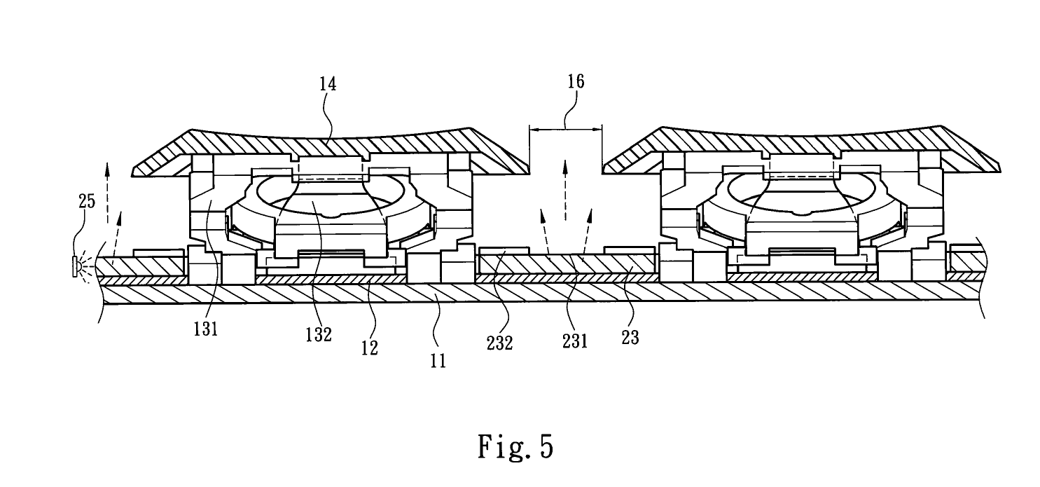

Refer to FIGS. 4 and 5 for a first embodiment of the present invention. The luminous portion 20 further includes an external light source 25 to provide light, such as a LED. The first and second lighting sections 22 and 23 have respectively a light permeable zone 221 and 231 and an impermeable zone 222 and 232. In the first embodiment the permeable zones 221 and 231 correspond to the first and second gaps 15 and 16, while the impermeable zones 222 and 232 correspond to the keycaps 14. When the external light source 25 projects light to the first and second lighting sections 22 and 23 the light passes through the permeable zones 221 and 231 and projects to the first and second gaps 15 and 16, thus increases the luminosity of the first and second gaps 15 and 16. As a result, the luminosity of the first and second gaps 15 and 16 is greater than that of the keycaps 14 to facilitate distinguishing of the locations of the keycaps 14.

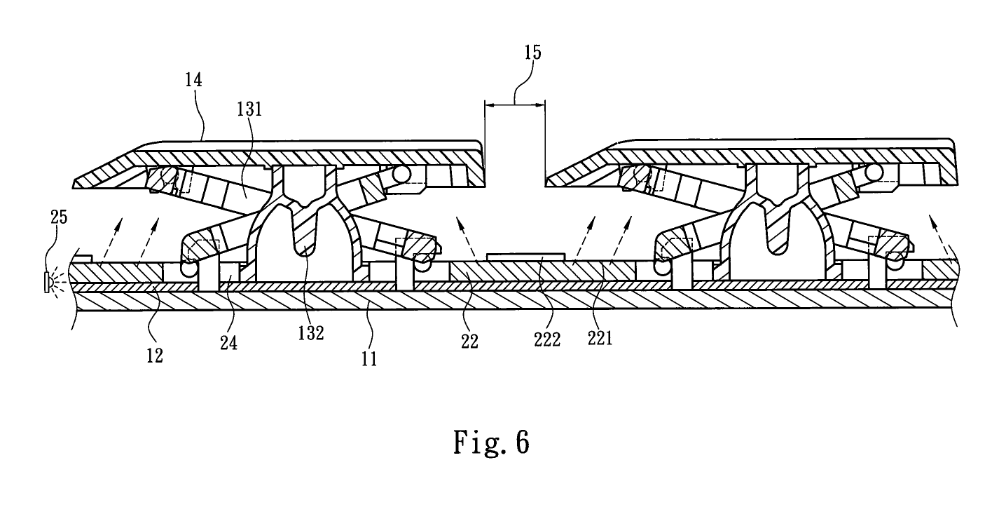

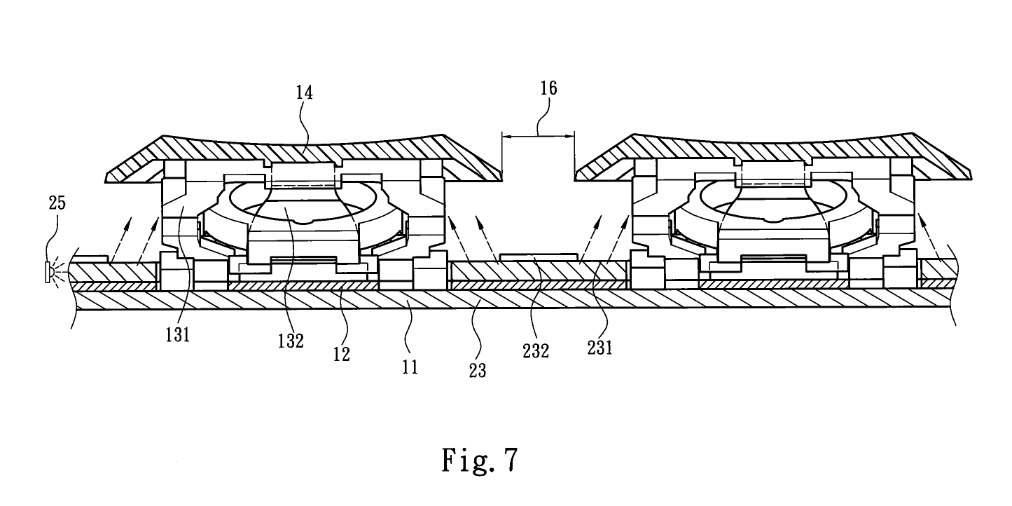

The present invention, aside from enhancing the luminosity of the first and second gaps 15 and 16 to distinguish the locations of the keycaps 14, can achieve the same result by enhancing the luminosity of keycaps 14. Refer to FIGS. 6 and 7 for a second embodiment of the present invention. It differs from the first embodiment by having the permeable zones 221 and 231 of the first and second lighting sections 22 and 23 corresponding to the keycaps 14 while the impermeable zones 222 and 232 corresponding to the first and second gaps 15 and 16. Hence the light of the external light source 25 is restricted by the impermeable zones 222 and 232 without reaching the first and second gaps 15 and 16, and projects merely to the keycaps 14 at a preset angle through the permeable zones 221 and 231. As a result, the luminosity of the keycaps 14 is greater than that of the first and second gaps 15 and 16 to facilitate distinguishing of the locations of the keycaps 14.

As a conclusion, the present invention mainly provides a luminous portion 20 containing a first lighting section 22 and a second lighting sections 23 corresponding to the first and second gaps 15 and 16 around the keycaps 14. The second lighting section 23 has two ends connecting to two adjacent first lighting sections 22 so that the luminosities of the keycaps 14 and the first and second gaps 15 and 16 are different. Whether the luminosity of the keycaps 14 or the first and second gaps 15 and 16 is greater, the locations of the keycaps 14 can be distinguished easier by users to improve keystroke accuracy of the illuminated keyboard.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. An illuminated keyboard provided distinguishable key locations, comprising:
a keyboard portion which includes a baseboard, a plurality of rows of keycaps located on the baseboard and a plurality of moving mechanisms bridging the keycaps and the baseboard to allow the keycaps to move up and down against the baseboard; the keycaps of neighboring rows being spaced by a first gap, the neighboring keycaps on each row being spaced by a second gap; and
a luminous portion which is located between the keycaps and the baseboard and includes a plurality of first lighting sections corresponding to the first gap and a plurality of second lighting sections corresponding to the second gap, the second lighting section including two ends connecting to two adjacent first lighting sections.

2. The illuminated keyboard of claim 1, wherein the first and second lighting sections include respectively a light permeable zone and an impermeable zone.

3. The illuminated keyboard of claim 2, wherein the light permeable zone corresponds to the first and second gaps so that the first and second lighting sections project light to the first and second gaps.

4. The illuminated keyboard of claim 2, wherein the light permeable zone corresponds to the keycaps so that the first and second lighting sections project light to the keycaps.

5. The illuminated keyboard of claim 1, wherein the moving mechanisms includes a movable member bridging the keycaps and the baseboard and an elastic element supporting the keycaps to provide a return force for the keycaps.

6. The illuminated keyboard of claim 1, wherein the keyboard portion further includes a circuit board to generate command signals by contact from the up and down movements of the keycaps.

7. The illuminated keyboard of claim 6, wherein the circuit board is located between the baseboard and the luminous portion.

8. The illuminated keyboard of claim 1, wherein the luminous portion is a light conductive object and includes an external light source to provide light input.

9. The illuminated keyboard of claim 8, wherein the external light source is a light emitting diode.

10. The illuminated keyboard of claim 1, wherein the first lighting section and the second lighting section are formed integrally.

11. The illuminated keyboard of claim 1, wherein the first lighting section and the second lighting section form an opening corresponding to the keycaps.
